(19) United States
(12) Patent Application Publication
(10) Pub. No.: US 2022/0374893 A1
(43) Pub. Date: Nov. 24, 2022

(54) NOVEL DATA EXCHANGE SYSTEM AND METHOD FOR FACILITATING A NETWORK TRANSACTION

(71) Applicant: RARE Corporation, Laramie, WY (US)

(72) Inventors: Christopher Rothfuss, Laramie, WY (US); Christopher Cacioppo, Kansas City, MO (US)

(73) Assignee: RARE Corporation, Laramie, WY (US)

(21) Appl. No.: 17/825,559

(22) Filed: May 26, 2022

Related U.S. Application Data
(63) Continuation of application No. 16/239,516, filed on Jan. 3, 2019.
Application No. 16/239,516 is a continuation-in-part of application No. 14/253,516, filed on Apr. 15, 2014, now abandoned.

(51) Int. Cl. G06Q 20/40; G06Q 20/38

(52) U.S. Cl. CPC G06Q 20/401; G06Q 20/405; G06Q 20/389

(57) ABSTRACT

The invention discloses a method and system for exchanging data between users using a transaction phrase, comprising: composing a data package by a source, uploading the data package onto a server, receiving a transaction phrase associated solely with the data package generated from a dictionary database utilized by the server, communicating the transaction phrase by the source to a recipient, requesting the data package by the recipient using the phrase, and receiving the data package from the server to the recipient if the parameters allow. The invention also details a financial aspect wherein a payment dialogue is initiated on the recipient interface allowing the recipient to complete a payment through a merchant server. Another embodiment comprises receiving a payment by the recipient upon submitting the transaction phrase to the server. The invention also envisions allowing the source to create a source account before composing the data package.

### PRIORITY

This application is a continuation of, and claims the benefit of, U.S. Nonprovisional patent application Ser. No. 16/239,516, filed on Jan. 3, 2019, the disclosure of which is hereby incorporated by reference. U.S. Nonprovisional patent application Ser. No. 16/239,516, is a Continuation-In-Part of, and claims the benefit of, U.S. Nonprovisional patent application Ser. No. 14/253,516, filed on Apr. 15, 2014, the disclosure of which is hereby incorporated by reference. U.S. Nonprovisional patent application Ser. No. 14/253,516 claims the benefit of U.S. Provisional Patent Application Ser. No. 61/833,549, filed Jun. 11, 2013, the disclosure of which is hereby incorporated by reference.

### FIELD OF INVENTION

The present invention generally relates to network transactions and more particularly to facilitating the transfer of information between users over a network.

### BACKGROUND OF INVENTION

With the advent of technology, consumers are becoming increasingly dependent upon portable electronic devices to complete everyday tasks. New applications are continuously created, which assist the user in completing daily activities quickly and efficiently. It is not uncommon to use a web based application for several tasks, including inviting guests to events, sharing data, communicating with others, making purchases online, and sharing music.

In most applications, in order to transmit or exchange information, a user must create a profile, which includes: submitting a valid email address, creating a password, and in some instances providing credit card or banking information to accomplish these tasks. While this is a necessary requirement to protect the user's identity, it can be time consuming, and tedious for many reasons.

First, since there are so many applications and programs online, users are required to remember a plurality of passwords, which over time have become subject to more stringent requirements due to increasing levels of security breaches. Requirements which once only required the choice of a simple word now require several different variations of characters, for example an upper case letter, a number, or a symbol. This level of difficulty in choosing and selecting a strong password, combined with the multitude of different passwords a user accumulates, results in a user continuously having to reset and change passwords and user names due to forgotten combinations. Because of this it has become increasingly difficult for a user to access protected information on websites or engage in online transactions.

Second, when making purchases online or sharing data, the user must create a user profile, which includes providing personal information to the site. The user then goes through the process of shopping for the item, which includes selecting items for purchase, placing them in a shopping cart, and going through the checkout process. At the point of checkout, the user is generally prompted to provide identifying information, which could be stored on the server, and then go through the process of purchasing the item with a credit card, electronic funds transfer, or other type of payment method. This process can be tedious and time consuming Further, the user's information may be stored, and therefore compromised and possibly used to steal the identity of the user, which leads to ruined credit, invasion of privacy, and general distress.

Another equally important concern is the use of credit cards to make purchases over the phone. It is becoming more common to use a credit card to make purchases remotely. Consumers use credit cards for simple purchases such as ordering food for take out, paying bills, purchasing items from department stores, services, and any number of items. There are great security concerns associated with this type of purchase. While some businesses may screen employees, it is very easy to have credit card information compromised when providing it over the phone, and therefore open oneself up to possible identity theft.

Several attempts have been made to remedy this situation. There are password management sites which consolidate all of a user's passwords to simplify the log in process. However, the master password requirements are difficult to create, and there is also an associated user profile. There is also the issue of discovery of a user's master password allowing a thief access to every site the user has stored.

What is needed is a way to securely transfer information between users without the requirements of a tedious, difficult password which is easily forgotten, or sharing of personal information, so that a person's privacy and anonymity is preserved, while still allowing the user to function online in today's society.

### SUMMARY OF INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some concepts in a simplified form as a prelude to the more detailed description that is presented later.

To resolve the problems mentioned above, an object of the present invention is to provide a method for exchanging data between users using a transaction phrase, comprising the steps of composing a data package by a source device on a first client interface, uploading the data package onto a transaction server using the first client interface, receiving a transaction phrase associated solely with the data package from the transaction server, the transaction phrase generated from a dictionary database located on the transaction server, the transaction phrase comprising combinations of one or more words selected from the dictionary database, communicating the transaction phrase to a recipient, transmitting the transaction phrase using a recipient device to the transaction server using a second client interface, and receiving the data package from the transaction server to second client interface.

In another embodiment of this method, the data package comprises a set of parameters and a piece of information. It is further envisioned that the set of parameters comprises at least one item selected from the group consisting, of a transaction lifetime, a source identification (“source id”), and a set of source preferences. Further, the transaction lifetime comprises at least one item selected from the group consisting of a length of time, a number of queries, or a combination of the length of time and the number of queries.

In another embodiment of the method, the data package is transmitted to the recipient device if the set of parameters indicate the data package is still valid otherwise, a null response is sent to the recipient device if the set of parameters indicate the data package is expired. In another embodiment of the invention, the first or second client interface may be a software application that is downloaded on the first or second device, or a website generated by the transaction server which is accessed by the first or second device. In yet another embodiment of the invention, the method further comprises transmitting a piece of configuration information with said transaction phrase by said recipient device via said second client interface to the transaction server.

In another embodiment of the invention. the dictionary database comprises one or more dictionaries containing sufficient words, symbols, or characters to generate the transaction phrase. The transaction phrase may consist of any length of words. In one embodiment of the invention the transaction phrase is at least two words but not more than five words. In the preferred embodiment of the invention the transaction phrase consists of three words.

In another embodiment of the invention, the method further comprises, checking the data package database periodically by the transaction server to evaluate the set of parameters, expunging the data packages from the data package database where the set of parameters indicate the data package is no longer valid, or archiving the data packages where set of parameters indicate the data package is no longer valid, and releasing the transaction phrase for future use with a new data package.

In yet another embodiment of the invention, the method details a financial aspect which further comprises: initiating a payment dialogue on the second client interface for the data package upon receipt from the transaction server, the payment dialogue displaying the set of source preferences. It is also envisioned that the recipient may select a means to pay by sending a payment request from the recipient device to a merchant server, completing a payment transaction through the merchant server, and transmitting a payment to the source from the merchant server. Another embodiment of the method further comprises transmitting a payment confirmation to the source device via the first client interface by the merchant server.

It is further envisioned that the method may comprise selecting a means to receive a payment by the recipient, sending a payment receipt preference from the recipient device to a merchant server, completing a payment transaction by the source device via a first client interface through the merchant server and receiving payment by the recipient from the merchant server. It is further envisioned in another embodiment, the method comprises, transmitting a payment confirmation to the recipient device by the merchant server.

In yet another embodiment of the invention, the method further comprises allowing the source to create a source account by requesting one from the transaction server on the first client interface prior to composing the data package by the first client interface, receiving a unique source id associated with the source account from the transaction server, which is generated by the transaction server, transmitting the set of source preference data with the unique source id to the transaction server, storing the set of source preference data and the unique source id under the source account located in the data package database by the transaction server, and then initiating data package composition by the source device via the first client interface.

In another embodiment of the method, the dictionary database comprises at least one dictionary selected from the group consisting essentially of: holiday themed words. seasonal themed words brand specific phrases, words from a specific part of speech, major languages, a dictionary containing less than 100 words, a 1000 word dictionary, or a 2000 word dictionary. Dictionaries may also be limited to specific words such as industry themed words or brand specific words. Specific dictionaries may have any number of words. For instance, a small dictionary may have between 10 and 100 words, a medium dictionary may have between 1000 and 10,000 words, and a large dictionary may include the entire lexicon of a specific language. The specific words used from a dictionary may be specifically selected to ensure ease of recognition when communicated orally, ease of spelling, and easy reproduction or transmittance. For dictionaries based on a written language, multiple dictionaries may be defined such that a phrase is easily remembered or transmitted. For instance, there may be one dictionary consisting of adverbs, another of adjectives, and another of nouns. The words may be used from each dictionary randomly to create a unique phrase. Multiple dictionaries may be used. In that way the words used may come solely from one dictionary or from a plurality of dictionaries. Additionally, dictionaries may include symbols rather than, or in addition to, words. For instance. a user may receive a picture of a dog, a picture of a bird, and a picture of an apple as a transaction phrase. The user then communicates the words “clog bird apple” to a recipient. The recipient then types in the words “dog bird apple” into the system to retrieve a data package. Other types of nonverbal symbols may be used as well, including videos, sounds. or colors.

Further, in yet another embodiment of the method, the piece of information comprises a piece of data selected from the group consisting essentially of: a text, an image, a piece of audio data, a bit of video data, a web page address (URL's), a hyperlink to a web page, a hyperlink to a document, an access token, a session token, or a bit of encryption data, advertisements, financial transaction information, coupons, or promotional offers.

The invention is also directed to a system for exchanging data between users using a transaction phrase, the system comprising: a first client interface configured to communicate over a network, a second client interface configured to communicate over the network, and a transaction server configured to communicate over the network. The transaction server comprises: a dictionary database, wherein upon receipt of a data package, the transaction server generates a transaction phrase for use solely with the data package using data from the dictionary database, the transaction phrase comprises combinations of one or more words selected from the dictionary database, and a data package database, which pairs the data package with the transaction phrase, and stores the data package and the transaction phrase in the data package database.

In another embodiment of the system, it is further envisioned that the first client interface is configured to compose a piece of information and a set of parameters into the data package, transmit the data package to the transaction server, receive the transaction phrase from the transaction server, and communicate the transaction phrase to the recipient independently of the transaction server. The second client interface is configured to receive a transaction phrase from the recipient device, process the transaction phrase, transmit the transaction phrase to the transaction server, receive the data package from the transaction server, or receive a null response if set data package has expired. The transaction server is configured to receive the data package from the first client interface, generate a transaction phrase solely for the data package using the dictionary database. transmit the transaction phrase back to the first client interface, pair the data package and the transaction phrase together, store the data package and the transaction phrase in the data package database connected to the transaction server, receive the transaction phrase from the second client interface, query the data package database for the transaction phrase, transmit the data package associated with the transaction phrase back to the second client interface if the set of parameters indicate the data package is not expired, transmit a null output to the second client interface if the set of parameters indicate the data package is expired, and evaluate the data package database to determine if the data package stored within the data package database is still valid, expunge the data package and release the unique identifier phrases if the set parameters indicate the data packaae is not valid.

In another embodiment of the system, it is further envisioned that the first or second client interface comprises a software application downloaded on the source or recipient device, or website generated by the transaction server.

In yet another embodiment, the system comprises a source id generator located in the transaction server, which is used to generate a unique source id for a source when requested by the source device via the first client interface.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 shows a system configuration in which the present invention may be practiced in accordance with one embodiment thereof.

FIG. 2 is a flowchart for a method of exchanging data between users using a transaction phrase.

FIG. 3 illustrates additional features of the method of FIG. 2.

FIG. 4 illustrates additional features of the method of FIG. 2.

FIG. 5 is a flowchart for another embodiment of the method of exchanging data between users using a transaction phrase which details a financial embodiment.

FIG. 6 illustrates an additional embodiment of the method of FIG. 2 and FIG. 5.

FIG. 7 illustrates additional features of the method of FIG. 5.

FIG. 8 illustrates an additional embodiment of the method of FIG. 2 and FIG. 5.

FIG. 9 illustrates an overview of the network system with a merchant server.

FIG. 10 illustrates a general overview of the use of the system.

### DETAILED DESCRIPTION OF THE PREFERRED EMBODIMENT

The claimed subject matter is now described with reference to the drawings. In the following description. for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface device”, or the like are generally intended to refer to a computer-related entity, either hardware, a combination of hardware and software, software, or software in execution. For example, a component may be, but is not limited to being, a method, an object, an executable, a thread of execution, a program, and/or a computer. By way of illustration, both an application running on a controller and the controller can be a component.

The system and method for exchanging data using a transaction phrase is a process designed to rapidly and easily transmit data packages between users. Each data package is accompanied by a transaction phrase. A user can enter the transaction phrase into the first or second client interface and instantly gain access to a data package. The invention is compatible with a broad range of information, from simple data files to entire encryption packages. In some embodiments the system and method for exchanging data using a transaction phrase may be configured to complete purchases and other financial transactions on behalf of the user, all using the transaction phrases.

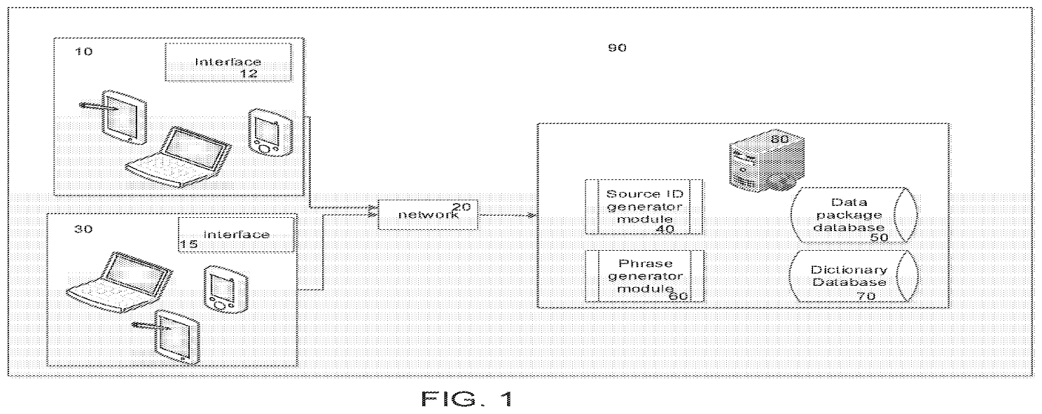

FIG. 1 is a block diagram of the system configuration in which the present invention may be practiced in accordance with one embodiment thereof. System 90 includes a source device 10, a recipient device 30, both of which connect to the server computer 80 via a first client interface (FCI) 12 and second client interface (SCI) 15 respectively, a network 20, and a transaction server 80. Network 20 is a data communication system, such as the internet.

Source device 10 and recipient device 30 may be any number of access devices capable of sending and receiving data. Both source device 10 and recipient device 30 are coupled to network 20. The source and recipient devices (10 and 30) may be a mobile phone, a laptop, a computer, a desktop computer, a tablet, or any other computational type of device used to communicate through the FCI 12 and SCI 15 with the transaction server 80 over the network 20. The FCI 12 and SCI 15 may be a software application downloaded on the respective devices (10 and 30), or a website generated by the transaction server 80.

The FCI 12 and SCI 15 are designed to be aesthetically simple consisting primarily of an input line for transaction phrase entry and an image of the invention logo. The FCI 12 and the SCI 15 are referred to herein as separate entities, but it should be understood that this is to differentiate between the source device actions and the recipient device actions, and that the actual FCI 12 and SCI 15 are a program that is either downloaded on the source and recipient device (10 and 30) or a website generated by the transaction server 80. The FCI 12 and SCI 15 are designed to be compatible with assisted entry programs to facilitate the entry of transaction phrases. The FCI 12 and SCI 15 may be compatible with several types of spoken entry assistance software, including voice pattern recognition software, voice searching software, and dictation software. The FCI 12 and SCI 15 are also designed to be compatible with written entry assistance software, and may also include additional features such as a QR code reader. a wallet for making purchases without interacting with a merchant service and a direct link to one or more merchant services. In some embodiments, as discussed in the financial process below, the SCI 15 initiates a payment dialogue with the recipient device 30 for the completion of financial transactions. The payment dialogue allows the recipient to confirm the details of a financial transaction and select the desired merchant service for completing it. The SCI 15 is designed to extract the information required to access the recipient's account with the merchant service selected in the payment dialogue for use in completing the transaction. In another embodiment, the SCI 15 may add additional configuration information such as encryption data or specified recipient information to the data being sent to the transaction server 80.

Hosted on the transaction server 80 is a dictionary database 70, a data package database 50, and a phrase generator module 60. In the embodiment displayed in FIG. 1, the server computer 80 also hosts a source id generator module 40. The transaction server 80 receives requests from the source and recipient devices (10 and 30) and responds by returning a transaction phrase generated by the phrase generator module 60 utilizing data pulled from the dictionary database 70, or a data package resulting from data pulled from the data package database 50. In some embodiments, as discussed further below, the transaction server 80 also links with the application programming interfaces (API's) of merchant services to perform financial transactions.

The transaction server 80 contains the dictionary database 70. The dictionaries stored in the dictionary database 70 contain sufficient words, symbols or characters to generate a desired number of transaction phrases. The dictionary database 70 may contain multiple dictionaries, with a different dictionary for each major language spoken by the users of system. Optionally, theme based sub-dictionaries may be included in the dictionary database for use at different times of the year. For example a sub-dictionary may contain seasonal or holiday themed words, such as “Santa” or reindeer for a holiday theme, or Spring, for a seasonal theme. The dictionary database 70 may be brand based, containing brand or product names, or contain individual or organization names, such as “Dave for a person's name,” or “Red Cross” for an organizational name.

In one embodiment, the dictionary database 70 contains a dictionary consisting of approximately I 000 words from a given language. In another embodiment, the dictionary database 70 contains a dictionary consisting of approximately 2000 words from any given language. The dictionary database 70 contains words that are short, preferably three to six characters in length, and easy to spell. The source letters of the words in the dictionary database 70 may also be distributed evenly across the alphabet. The words selected to be contained in the dictionary database 70 are designed to have a unique, clear sound for easy vocal input.

The phrase generator module 60 is designed to pull data from the dictionary database 70 to create transaction phrases for the users of the system 90. Upon receiving a data package, the transaction server 80 utilizes the phrase generator module 60 to aenerate a transaction phrase for the data package, known as the transaction phrase. The transaction phrase is generated by the phrase generator module 60 from the dictionaries contained in the dictionary database 70. The transaction phrases are generally comprised of two or greater dictionary words which provide sufficient phrase combinations. In some embodiments, two or less dictionary words may be used, if the dictionaries in the dictionary database 70 are of sufficient size, or if other scope limiting information is used, such as geographic location, or an associated IP address.

The transaction phrases are designed to be as distinct from one another as possible to avoid accidental entry of an incorrect phrase. Transaction phrases may be combinations or permutations of the phrase words. Combinations are generally preferable, such that no two transaction phrases contain the same set of words. In some embodiments, permutations may be used to extend the number of transaction phrases for a given dictionary. The number of available combinations for transaction phrases is dependent upon the size of the dictionary. For a three word Transaction Phrase, there are approximately 665 million combinations in a 1000 word dictionary, and approximately 5.3 billion combinations in a 2000 word dictionary.

The data package database 50 is also housed in the transaction server 80, and is used to store all data packages and transaction phrases for later access by the recipient device 30. Data packaaes are initially received from the source device 10 using the FCI 12 and stored in the data package database 50. The transaction server then utilizes the phrase generator module 60 to pair a transaction phrase solely with the data package and stores both in the data packaae database 50. When a recipient device 30 requests the data package from the transaction server 80 through the SCI 15, using the associated transaction phrase, the transaction server 80 queries the data package database 50 for the data package stored under that phrase, and returns it to the recipient device 30. The data package database 50 is a constituent part of the transaction server 80 and contains all of the information intended for use by the recipient device 30. The data package database 50 is designed to store and organize all of the data packages, for rapid access by the transaction server 80.

The source id generator module 40 is also housed in the transaction server 80. The source id generator module 40 is designed to generate a unique source id upon request from a source device 10. Upon receiving a request from a source device 10, the source id generator 40 generates a unique source id, which is registered and stored in the data package database 50. The unique source id is not restricted to dictionary words and may take the form of long alphanumeric codes.

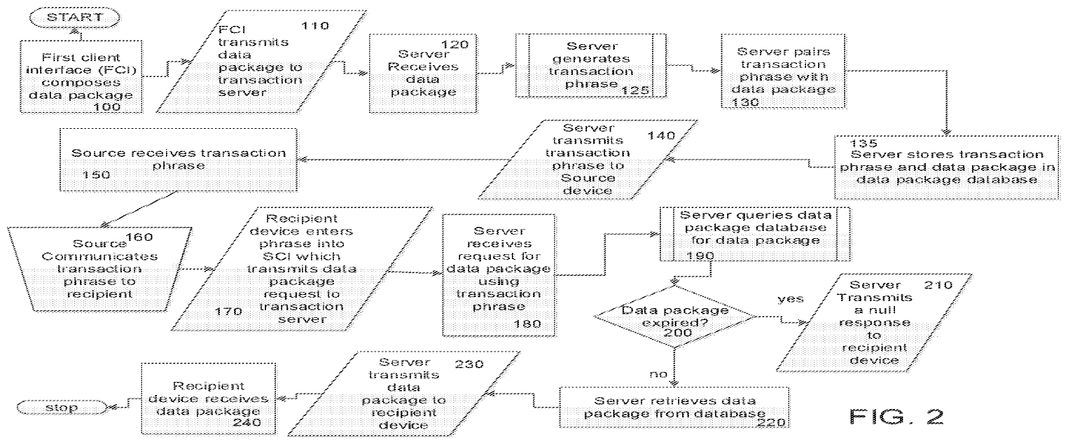

FIG. 2 a flowchart for a method of exchanging data between users using a transaction phrase. To begin, a data package is composed by the FCI 100 and transmitted to the transaction server 110. The transaction server receives the data package 120, then generates a transaction phrase 125 and pairs it with the data package 130 before storing them both in the data package database 135. The transaction phrase is transmitted to the source device 140 through the FCl 12. The source receives the transaction phrase 150, and communicates it to the recipient 160. The transaction phrase is not communicated from the source to the recipient through the interfaces 12 and 15, but is instead provided through some other form of communication, for example through spoken word, printed receipt, mailed letter, printed or spoken advertisement, or other means.

The recipient device 30 enters the transaction phrase into the SCI 15 which transmits the transaction phrase to the transaction server 170. The transaction server receives the request 180 from the recipient device 30, and uses the transaction phrase to query the data package database for the associated data package 190. The server then checks to see if the data package has expired 200. If the data package has expired, the database will produce a notification that the data package has expired and the server will transmit the null response to the recipient device 210. If the data package has not expired, the transaction server will retrieve the data package from the database using the transaction phrase 220, and transmit the data package to the recipient device 230. The recipient, upon receiving the data package to the recipient device 240, then takes any additional action that may be warranted by the information within the data package. If the information contained within the data package is a picture file, for example, this invention may be optionally configured to allow the recipient to download the picture to another device, forward the picture in an email and/or share the picture on a social networking website in addition to merely viewing it. In the event that the data package contains information related to a financial transaction, the “further actions” will be the completion of said transaction.

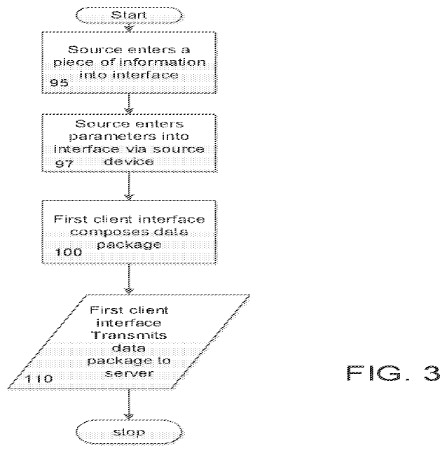

FIG. 3 illustrates additional features of the method of FIG. 2, specifically the creation of the data package. The information exchange is initiated with the creation of a data package by the FCI. To begin, the source device enters the piece of information to be transferred into the FCI 95. The source device then enters the set of parameters into the FCI 97. The FCI composes this data into a data package 100, which is transmitted to the transaction server 110. The piece of information may be comprised of any useful piece of information, such as text data or text files, image, audio or video files, web paae addresses (URL's), hyperlinks to a web page or document, session tokens or access tokens, encryption data, such as ciphers and cipher text, and/or information for completing a financial transaction.

The set of parameters may include the source id, transaction lifetime, and any additional source preferences. The transaction lifetime is the duration that the given data package lasts before it expires. The lifetime of the data package is selected on the FCI, and may be either a length of time, such as I hour or 30 days, a number of queries, such as the data package being accessed 25 times, or a combination of both. An example of a time restricted transaction lifetime would be a bill for a restaurant transaction. An example of a number of queries restricted transaction lifetime would be a coupon code for a product sale.

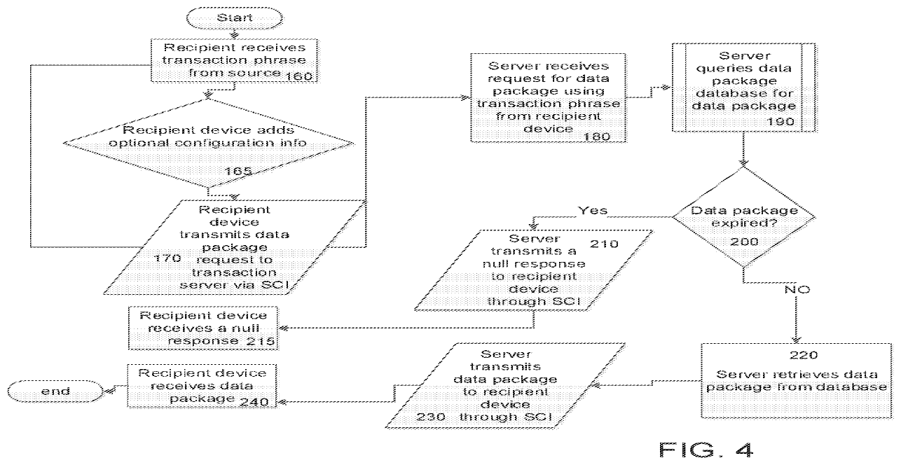

FIG. 4 illustrates additional features of the method of FIG. 2, specifically the recipient/server interactive process. The method begins with the receipt of the transaction phrase by the recipient from the source 160. The communication of the transaction phrase is done independently of the transaction server, for example, spoken word, printed receipt, or another method. Upon receipt of the transaction phrase 160, the recipient device may add additional configuration information to the transaction phrase in the SCI such as recipient info, or encryption data 165. The recipient device then transmits the data package request via the SCI to the transaction server 170, where it is received by the transaction server 180. For the data package request, the recipient enters the transaction phrase into the server via the SCI. The transaction server then queries the data package data base using the transaction phrase for the data package 190, The server then checks to see if the data package has expired 200. If the data package has expired, a null response is transmitted to the recipient device via the SCI 210. If the data package has not expired, the transaction server retrieves the data package from the database 220, and transmits the data package to the recipient device via the SCI 230. The recipient receives the data package 240, and takes any other actions necessary.

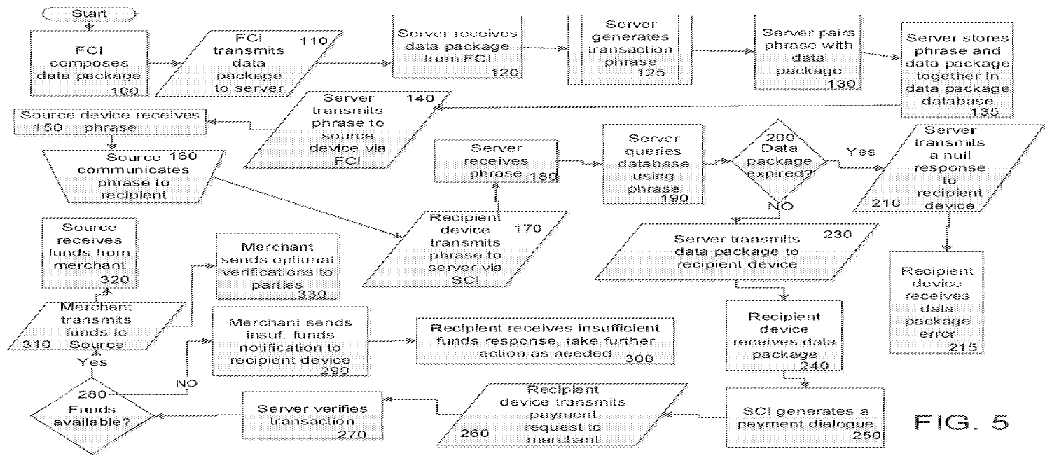

FIG. 5 is a flowchart of the method of exchanging data between users using a transaction phrase which details a financial embodiment. In this embodiment, a financial transaction is completed through the use of a merchant server. To begin, the FCI composes the data package 100 using the details of the financial transaction provided by the source device. and desired set of parameters. The selected parameters may include the transaction lifetime, the Source ID (see below for creation process), payment preferences, whether gratuity is allowed and other information. The FCI composes this data into a data package 100, which is transmitted to the transaction server 110. Upon receipt of the data package 120, the transaction server generates a transaction phrase 125 and pairs the phrase with the data package 130 before storing them both in the data package database 135. The transaction phrase is then transmitted to the source device via the FCI 140, where it is received by the source device 150, and communicated by the source to the recipient 160. Note that the transaction phrase is not communicated from the source to the recipient through the server, but is instead provided through some other form of communication such as spoken word, printed receipt. or any other means.

Upon receipt of the transaction phrase, the recipient enters the transaction phrase into the SCI using the recipient device and the transaction phrase is then transmitted to the transaction server 170, which receives the phrase 180 and uses the transaction phrase to query the data package database for the associated data package and source information 190. The server then checks to see if the data package has expired 200. If the data package has not expired, the server will transmit the data package to the recipient device 230. However, if the data package has expired, the database will produce a notification stating that the transaction cannot be completed, which will be transmitted by the server to the recipient device 210. The recipient device then receives a data package error 215.

Once the recipient device receives the data package 240, the SCI generates a payment dialogue 250. The information entered into the payment dialogue is then compiled into a payment request and sent to the merchant server 260. After receiving the payment request the merchant server then verifies the transaction with the transaction server 270. The merchant server then confirms that the recipient has sufficient funds available complete it 280. If the transaction is approved, the merchant server releases funds from the recipient's account and transmits funds to the source 310 where they are received in accordance with the source's payment preferences 320. The merchant server then sends optional payment confirmation to the relevant parties 330.

Additional options designed with the system and method not shown may include a payment verification sent to the source device to serve as a record of the transaction. The FCI may also optionally be configured to automatically trigger internal reporting events upon the receipt of payment confirmation for example, activate accounting or inventory management software. In other embodiments, the source may issue funds back (refunds) to the recipient account upon request from the recipient. Other options may be performed by the merchant server as well. For example, payment verification may optionally be sent to the transaction server. This payment confirmation may be used for recordkeeping, and may be optionally used to mark completed transactions for removal from the data package database. Payment verification may also be sent back to the recipient device in accordance with the preferences previously entered into the payment dialogue.

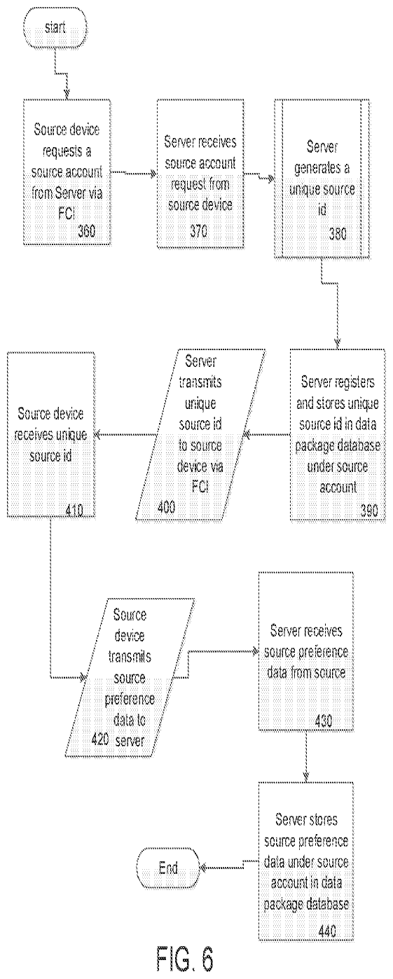

FIG. 6 illustrates an additional feature of the method of FIG. I and FIG. 5, specifically creating a source account for storage on the transaction server 80. Prior to initiation of a transaction, the source may desire to establish a source account on the transaction server that provides certain information and options relating to source transactions. This process begins with the source device requesting an account via the FCC on the transaction server 360. The transaction server receives the request 370 and then generates a unique source id 380 using the source id generator module. The unique source id izenerated by the source id generator module, is not restricted to dictionary words, and may take the form, of long alphanumeric codes.

The transaction server then registers and stores the unique source id in the data package database under the source account 390. The unique source id is transmitted back to the source device 400, and received by the source device 410. The source device then transmits to the transaction server any required source preference data 420. The transaction server receives the source preference data from the source 430, and stores it under the source account in the data package database 440. Source preference data can be anything the source desires, including: the business name of the source, the business location of the source. the merchant services accepted by the source, business reporting requirements for the source, including which information to report. (inventory management data, etc.) the IP address of the source, and whether gratuity is allowed. In some embodiments, a sub-identifier may be made available to the source to identify the different components of the business/organization of the source, for example, multiple branches of a chain store.

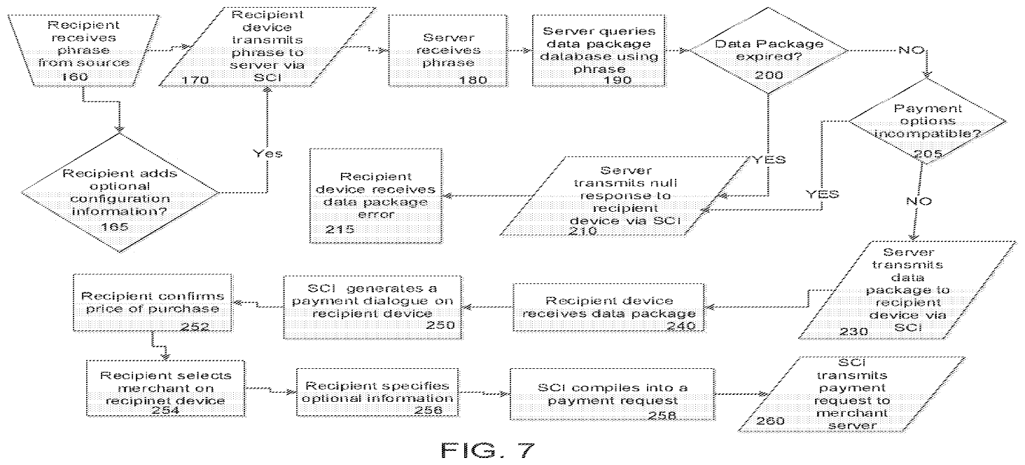

FIG. 7 illustrates additional features of the method of FIG. 5, specifically, the interaction between the recipient and the transaction server. Once the recipient receives the transaction phrase from the source, the recipient may enter additional configuration information such as recipient information or encrypt the data being sent to the transaction server 165. The recipient device then transmits the transaction phrase to the transaction server via the SCI 170. The transaction server receives the transaction phrase 180, and queries the data package database for the associated data package 190. The transaction server checks to see if the data package has expired 200, if so, the transaction server transmits a null response to the recipient device 210. which then receives a data package error 220. If the data package has not expired, the transaction database verifies the payment options set up by the source are compatible with those set up by the recipient 205. If the payment options are incompatible the transaction server transmits a null response to the recipient device via the SCI 210, and the recipient device receives a data package error 215. If the payment options are compatible, the transaction server transmits the data package to the recipient device via the SCI 230.

Upon receipt of the data package by the recipient 240, the SCI generates a payment dialogue on the recipient device 250. The payment dialogue displays the details of the transaction, such as the price of the product or service being purchased, the transaction lifetime and the source information. The SCI is also the interface for the recipient to complete the transaction. The recipient then confirms the price of the purchase 252, and selects which merchant to use for payment on the recipient device 254. The recipient may also specify optional information such as receipt preferences and gratuity amount 256. The information entered into the payment dialogue is then compiled into a payment request 258 and transmitted to the merchant server via the SCI 260. The payment request also contains the information required to access the recipient's account with the merchant server, which may be either entered manually by the recipient through the payment dialogue or retrieved automatically from the recipient's device by the SCI.

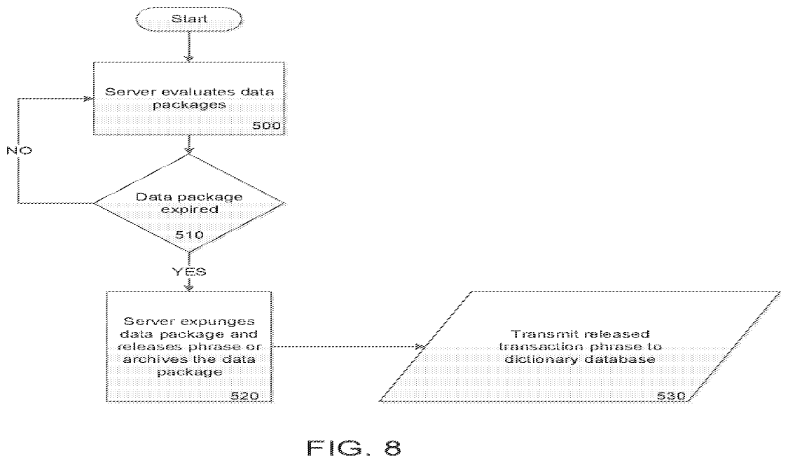

FIG. 8 illustrates additional features of the method of FIG. 2 and. FIG. 5. In this embodiment, the transaction server periodically scans the data packages stored in the data package database to determine whether they have exceeded their specified transaction lifetimes. If the data package has not exceeded its lifetime, no additional action is taken. In the event that a data package has exceeded its transaction lifetime, the data package is deleted from the data package database and the associated transaction phrase is released for use with another package. The method begins when the transaction server evaluates the data packages 500. If there are data packages in the data base with expired lifetimes 510, the transaction server expunges the data packages or optionally archives the data package, and releases the transaction phrase 520. The transaction server then transmits the released transaction phrase back to the dictionary database for use with another data package 530.

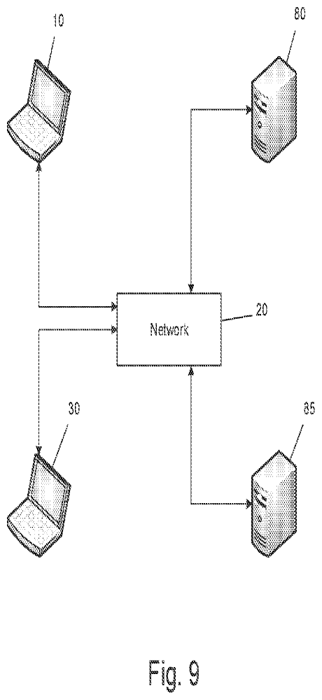

FIG. 9 is a general overview of the system utilizing a merchant server. In this system, a source device 10.. a recipient device 30, a transaction server 80, and a merchant server 85 are connected via a network 20. In this system, a user of the source device 10 can send or receive payment from a merchant server 85 to or from a user of the recipient device 30 utilizing the mechanism of the transaction server 80. The merchant server 85 may be directly connected with the transaction server 80. The merchant server 85 may be operated by a third party or may be operated by the operator of the transaction server 80. Alternatively, the merchant server 85 may be the exact same server as the transaction server 80.

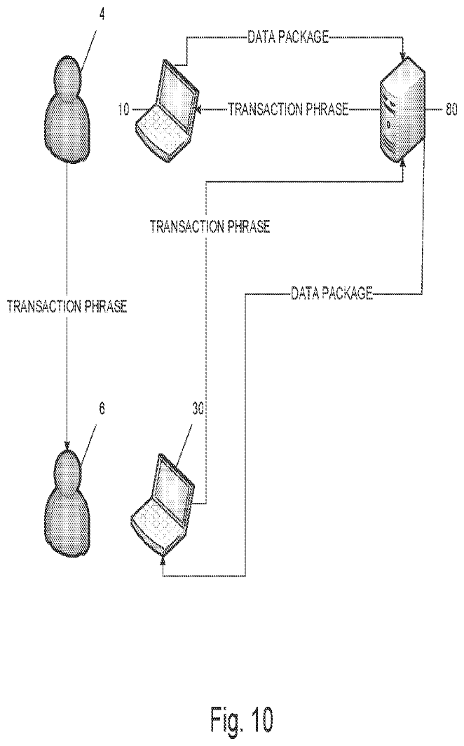

FIG. 10 is a general overview of the utilization of the system. A first user 4, via a source device 10, sends a data package to the server 80. The server 80 returns a transaction phrase to the source device 10. The first user 4 sends the transaction phrase to the second user 6. The second user 6, via a recipient device 30, sends the transaction phrase to the server 80. The server, upon receiving the transaction phrase, sends the data package to the recipient device 30.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The system may be used for any purpose for which the generated transaction phrase may replace the use of a password for accessing a computer system or performing a transaction on a computer system. The system may be complemented with a process for completing any financial transaction. For illustrative purposes only, a consumer may order food from a restaurant over the phone. An employee at the restaurant creates an online cart and enters the cart into the system. The server computer 80 generates a unique three word phrase. The restaurant employee verbally conveys the three word phrase to the consumer. The consumer enters the three word phrase into the SCI 15. The server computer 80 retrieves the cart with the amount due. The consumer then chooses a method for paying through a merchant processor. The processor sends the funds to the restaurant and the transaction is complete. As another example, a user desires to send funds to a recipient. The user selects an amount to send and selects the source of the funds to be retrieved from (such as from a checking account, a third party deposit account, or a linked credit card). The user enters this information into the FCI 10. The user is given a unique three word phrase. The user then verbally conveys the three word phrase to the individual the user wishes to send the funds to. The recipient enters the three word phrase into the SCI 15 and the system transfers the funds to the location which the recipient has selected. These examples are provided for illustrative purposes only and are not intended to limit the scope of the invention in any manner.

The method of transmitting payment through the sole use of a phrase has massive benefits. The transmission of the transaction phrase to complete the financial transactions is not required to be encrypted because the transaction phrase does not contain any sensitive payment or account information. This benefit allows the computer systems to execute the method faster because encryption of the communications is not required. In the method, one or more transmissions of the transaction phrase may be unsecure and unencrypted.

The method can include other steps, such as transmitting the transaction phrase automatically to the recipient device—by either the transaction server, the source device, or by an email application miming on the source device. The method may include the process of displaying information from the data package on the recipient's device.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital sianal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function,

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module. which may reside on a tangible, non transitory computer-readable storage medium. Tangible. non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for exchanging data between users using a transaction phrase, comprising the steps of:
a. composing a data package by a source device on a first client interface;
b. uploading said data package onto a transaction server using said first client interface;
c. receiving a transaction phrase associated solely with said data package from said transaction server;
i. wherein said transaction phrase is generated from a dictionary database located on said transaction server;
ii. wherein said transaction phrase comprises combinations of one or more words selected from said dictionary database;
d. communicating said transaction phrase to a recipient;
e. transmitting said transaction phrase from using a recipient device to said transaction server using a second client interface;
f. receiving said data package from said transaction server to second client interface.

2. The method of claim 1, wherein said data package comprises a set of parameters and a piece of information.

3. The method of claim 2, wherein said set of parameters comprises at least one item selected from the group consisting of: a transaction lifetime, a source id, and a set of source preferences.

4. The method of claim 3 wherein said transaction lifetime is comprises at least one item selected from the group consisting of: a length of time, a number of queries, or a combination of said length of time and said number of queries.

5. The method of claim 4 wherein said data package is transmitted to said recipient device if said set of parameters indicate said data package is still valid; or a null response is sent to said recipient device if said set of parameters indicate said data package is expired.

6. The method of claim 5 wherein said first or second client interface comprises a software application downloaded on said source or recipient device, or a website generated by said transaction server.

7. The method of claim 6, further comprising: transmitting a piece of configuration information by said recipient device using said second client interface to said transaction server with said transaction phrase.

8. The method of claim 6, wherein said dictionary database comprises one or more dictionaries containing sufficient words, symbols, or characters to generate said transaction phrase.

9. The method of claim 1 further comprising:
a. requesting a source account from said transaction server, prior to composing said data package by said first client interface;
b. receiving a unique source id associated with said source account, said unique source id generated by said transaction server;
c. transmitting said set of source preference data with said unique source id to said transaction server;
d. storing said set of source preference data and said unique source id under said source account located in said data package database by said transaction server;
e. initiating data package composition on said first client interface using said source device.

10. A method for exchanging data between a source and a recipient to complete a financial transaction using a transaction phrase, comprising the steps of:
a. requesting a source account from said transaction server prior to composing said data package by said first client interface;
b. receiving a unique source id associated with said source account, said unique source id generated by said transaction server;
c. transmitting a set of source preference data with said unique source id to said transaction server;
d. storing said set of source preference data and said unique source id under said source account located in said data package database by said transaction server;
initiating data package composition by said first client interface on said source device,
i. said set of parameters comprising: a transaction lifetime, and said source id,
ii. said transaction lifetime comprising at least one item selected from the group consisting of: a length of time, a number of queries, or a combination of a length of time and a number of queries;
f. uploading said data package onto said transaction server using said first client interface;
g. receiving a transaction phrase associated solely with said data package from said transaction server,
i. said transaction phrase generated from a dictionary database located on said transaction server,
ii. said transaction phrase comprising combinations of one or more words selected from said dictionary database,
iii. said transaction phrase paired solely with said data package and stored in said data package database;
h. communicating said transaction phrase to a recipient;
i. transmitting said transaction phrase using a recipient device to said transaction server using a second client interface;
j. receiving said data package request from said second client interface;
k. querying said data package data base for said data package;
l. verifying whether said set of parameters indicate said data package is still valid;
m. transmitting said data package from said transaction server to said second client interface, if said set of parameters indicate said data package is still valid;
n. initiating a payment dialogue on said second client interface, said payment dialogue displaying said set source preferences;
o. selecting a means to pay by said recipient device;
p. sending a payment request from said recipient device via second client interface to a merchant server;
q. completing a payment transaction through said merchant server;
r. transmitting a payment confirmation to said source device by said merchant server;
s. checking said data package database periodically by said transaction server to evaluate said set of parameters;
t. expunging said data packages from said data package database where said set of parameters indicate said data package is no longer valid, or archiving said data packages where set of parameters indicate said data package is no longer valid;
u. releasing said transaction phrase for future use with a new data package.

11. A system for exchanging data between users using a transaction phrase, comprising:
a. a first client interface, said first client interface configured to communicate over a network;
b. a second client interface, said second client interface configured to communicate over said network;
c. a transaction server, said transaction server configured communicate over a network, said transaction server comprising:
i. a dictionary database,
1. wherein upon receipt of a data package, said transaction server generates a transaction phrase for said data package,
2. wherein said dictionary database is used to create said transaction phrase for use solely with a data package,
3. wherein said transaction phrase comprises combinations of one or more words selected from said dictionary database;
ii. a data package database,
1. wherein said data package database pairs said data package with said transaction phrase, and stores said data package and said transaction phrase in said data package database.

12. The system of claim 11, wherein
a. said first client interface is configured to compose a piece of information and a set of parameters into said data package, transmit said data package to said transaction server, receive said transaction phrase from said transaction server, communicate said transaction phrase to said recipient independently of said transaction server;
b. said second client interface configured to receive a transaction phrase from said recipient device, process said transaction phrase, transmit said transaction phrase to said transaction server, receive said data package from said transaction server, or receive a null response if set data package has expired;
c. said transaction server configured to,
i. receive said data package from said first client interface, generate a transaction phrase solely for said data package using said dictionary database, transmit said transaction phrase back to said first client interface, pair said data package and said transaction phrase together, store said data package and said transaction phrase in said data package database connected to said transaction server,
ii. receive said transaction phrase from said second client interface, query said data package database for said transaction phrase; transmit said data package associated with said transaction phrase back to said second client interface if said set of parameters indicate said data package is not expired, transmit a null output to said second client interface if said set of parameters indicate said data package is expired;
iii. evaluate said data package database to determine if said data package stored within said data package database is still valid, expunge or archive said data package and release said unique identifier phrases if said set parameters indicate said data package is not valid.

13. The system of claim 12 wherein said first or second client interface comprises: a software application downloaded on a source or said recipient device, or a website generated by said transaction server.

14. The system of claim 12, further comprising: a source id generator located in said transaction server, said source id generator used to generate a unique source id for a source when requested on said source device using said first client interface.

15. The system of claim 12, wherein said dictionary database comprises at least one dictionary selected from the group consisting essentially of: holiday themed words, seasonal themed words, brand specific phrases, words from a specific part of speech, major languages, a dictionary containing less than 100 words, a 1000 word dictionary, a 2000 word dictionary, or a 10,000 word dictionary.

16. The system of claim 12, wherein said piece of information comprises a piece of data selected from the group consisting essentially of: a text, an image, a piece of audio data, a bit of video data, a web page address (URL's), a hyperlink to a web page, a hyperlink to a document, an access token, a session token, or a bit of encryption data, advertisements, financial transaction information, coupons, or promotional offers.
